(19) United States
(12) Patent Application Publication
(10) Pub. No.: US 2003/0041639 A1
(43) Pub. Date: Mar. 6, 2003

(54) Soil conditioner and water vitaliser

(76) Inventors: Dieter Meyer, Bad Nenndorf (DE); Hans-Peter Braun, Neustadt (DE)

Correspondence Address: WILLIAM COLLARD, COLLARD & ROE, P.C., 1077 NORTHERN BOULEVARD, ROSLYN, NY, 11576, US

(21) Appl. No.: 10/208,555

(22) Filed: Jul. 30, 2002

(30) Foreign Application Priority Data
Aug. 22, 2001 (EP) 01 120 106.8

(51) Int. Cl. C05C 1/00

(52) U.S. Cl. 71/27

(57) ABSTRACT

The invention relates to a soil conditioner comprising a mixture of an aqueous solution manufactured with constant stirring of sodium hydroxide, acetic acid and 1,2,3-propanetriol and an aqueous solution produced under constant stirring from saccharose, potassium hydrogentartrate and acetic acid.

The present invention relates to a soil conditioner according to the preamble of Claim 1 and a water vitaliser according to Claim 11.

Soil conditioners comprise substances which in relatively small quantities already improve the general soil structure such as granulation, degree of loosening, permeability to gas or water-binding capability and thus promote the development and spread of microbes.

By way of contrast, fertilisers contain only those nutrients which are meant to balance the deficits of the soil in minerals, nitrogen and phosphorous. Manuring, however, has no positive influence on the soil structure, but rather leads to impoverishment of the soil. This is to be attributed in particular to the decrease of microbes living in the soil and higher living organisms caused by manuring. The accumulation of harmful substances such as nitrates in ground water is also known as a negative attendant phenomenon of intensive manuring.

The use of soil conditioners therefore represents a measure for maintaining and increasing the fertility of the soil, without the known disadvantages of conventional manuring and soil treatment. In particular a soil conditioner is supposed to activate the microbes living in the soil. The activated microbes stimulate the nitrogen cycle of the plants, since basically only they are in a position to bind elementary nitrogen from the air and to convert it into nitrogen compounds available to plants. Of these plants only lupins can directly fix elementary nitrogen.

Soil is designated as the top layer of the earth's crust, where decomposition procedures take place which essentially contribute to soil development. In chemical terms decomposition is characterised above all by the high mobility of water and by the participation of ions and organic substances as well as by changes in pH. Plant roots and lower representatives of soil flora such as bacteria, algae and moulds contribute in particular to biochemical decomposition.

In soils in biological balance the top, mostly humus-containing layer is rich in organic material and soil organisms and forms that part of the soil which is most important for nourishing the plants. Humus generally describes all the dead plant and animal substances found in the soil. The development of humus is the combined work of ground animals and microorganisms.

The pH value of the soil likewise plays an important role. Balancing out the supply of H⁺ ions resulting from the breathing of the plant roots in soils in biological balance is a quantity of carbonates and soil bases which provide buffering and cause a basic or neutral reaction of the soil. Such soil ratios are required by a large number of cultivated plants. An additional H⁺ ion supply by acid rain accelerates the dissolving decomposition of carbonates and washing out of nutrients. The effects of acid rain thus prove to be a disturbance to the ecological balance as a result of acidification of waters and soils with less buffer capacity.

Accumulations of heavy metal salts can have a toxic effect on the plants. It is also known that heavy metals can be made available by altering the pH value for the plants. In particular, wild mushrooms can absorb substantial quantities of toxic heavy metals such as cadmium. In general, this results in so-called mobilising of heavy metal ions. These mobilised heavy metal ions can then easily find their way into the ground water.

By way of example, cow dung, green manure, lime, humus, peat dust, lignin derivates, alginates, pectins, iron sulfate, calcium polysulfide, sawdust or silicate are used as soil conditioners in the broadest sense. The drawback to these soil conditioners is their brief and one-sided mode of action. They are not suited to counteracting soil acidification and the toxic charging of soils or supporting natural humus development. In addition, the use of sawdust is forbidden in some countries. Cow dung is often used in excessively high concentrations and leads to overmanuring of soils. The ecological balance of soils can be temporarily restored in any case.

Greater meaning is attached to synthetic products, which are rejected however for environmental reasons.

Desert soils are frequently lacking a layer of humus necessary for plant growth whenever there is insufficient water supply. Moreover, it has eventuated that the water used for irrigation evaporates or seeps away too quickly. Using salt water for irrigation results in disadvantageous oversalting of desert soils.

Excessive watering though otherwise leads to salinisation of desert soils, because salts from deeper soil layers enter the upper soil layers penetrated by plant roots.

DE 37 44 569 C1 discloses a soil conditioner having a soil-compatible electrolyte and invert sugar content in a ratio of 20:1 to 1:10. Sodium acetate is preferably used as electrolyte. The invert sugar is preferably an inverted saccharose with an inversion degree of 55 to 75%, particularly preferably 60 to 70%. According to an advantageous embodiment of the invention the soil conditioner is present as an aqueous solution which contains approximately 0.01 to 1.0% by weight, in particular 0.1% by weight of a mixture of electrolyte and invert sugar.

Such a soil conditioner should regenerate the soil such that there is improved absorption of nutrients by the plants with a resulting increase in agricultural yields. But the drawback here is that the nutrients and the moisture are stored in the soil in minimal quantity only, so that the introduced substances are washed out relatively rapidly with repeated irrigation.

DE 33 32 222 A1 discloses a method for producing a soil vaccine and a soil vaccine manufactured according to the method described. An aqueous solution is used as soil vaccine, which comprises 60% by weight sodium hydroxide solution, 30% by weight acetic acid and 10% by weight glycerine. For a preferred mixture of the soil vaccine 50% sodium hydroxide solution, 25% acetic acid and 85% glycerine are used. For another preferred mixture of the soil vaccine 30% sodium hydroxide solution, 5% acetic acid and 50% glycerine are used.

Such a soil vaccine serves to neutralise acidified soils, effectively improving the growth of plants and microorganisms.

Based on the prior art the object of the present invention is to provide a soil conditioner which restores the ecological balance of soils.

This problem is solved in a soil conditioner according to the preamble of Claim 1 by the features of Claim 1. Further developments and advantageous embodiments of the invention will emerge from the sub-claims.

According to the present invention the soil conditioner is a mixture of a first aqueous solution of sodium hydroxide, acetic acid and 1,2,3-propanetriol produced under constant stirring and a second aqueous solution of saccharose, potassium hydrogentartrate and acetic acid produced under constant stirring.

Such a mixture used for treating soils leads to increased plant growth as compared to known soil conditioners. Although the exact effect of the soil conditioner is unknown, success shows up after only a few days in terms of an increase in the concentration of the green leaf dye chlorophyll found in plants.

Yellowed and sick plants can surprisingly be regreened and vitalised. For this reason the soil conditioner according to the present invention is designated as a soil vitaliser.

The soil vitaliser has inter alia a direct influence on the pH value of the soil and within a very brief period reestablishes the biological balance in the soil. The soil can absorb more nutrients and moisture and store these over a longer period. The danger of so-called mobilising of heavy metal ions is also reduced.

Increased absorption and storage of nutrients and moisture on the one hand has a direct influence on plant growth, because the substances required for plant growth are available over a longer period. But on the other hand there is also a direct influence on plant growth, resulting from a strong increase in animals and microorganisms living in the soil. The soil is practically vitalised, leading to increased humus development. Humus then again directly represents a good nutrient base for the plants.

Field trials in desert regions of Saudi Arabia and the United Arab Emirates have uncovered more surprising results. The desert soil treated with the soil vitaliser and then irrigated still stores water for weeks despite intensive solar radiation. Utilising water used for irrigation can be reduced and rapid salinisation of the soil can be counteracted. Effective storage of water is firstly attributable to the overall hygroscopically designed system of soil vitalisers. In addition, the developing microbes and the developing humus provides effective water storage.

The mixing ratio of the individual aqueous solutions is dependent on the nature of the soils to be treated and can be determined by simple field trials or soil analysis.

The mixing ratio between both the solutions should be such that an effective buffer system of acetic acid and sodium acetate results, which is effective against both acids and bases. The effect of the buffer substances contained in the soil vitaliser according to the present invention is based on the intercepting reaction of H⁺ or OH⁺ ions with the formation of weak acids or bases on account of their dissociation equilibrium. Acidification of the soil is thus counteracted. Buffering also prevents heavy metal ions serving partly as trace elements from being washed out. These trace elements can then be absorbed by the plants via the roots.

Preferably the mixing ratio of the first aqueous solution to the second aqueous solution is approximately 1:10 to 1:50, whereby a temperature of 80° C. may not be exceeded when the solutions are being mixed.

A further development provides that while the solutions are being mixed air, pure carbon dioxide and/or pure oxygen are introduced to the mixture.

The result is a soil vitaliser containing dissolved carbon dioxide and/or dissolved oxygen. The dissolved oxygen acts to activate the microbes living in the soil. A desired buffer system of sodium carbonate and hydrogen carbonate can be advantageously established by the introduction to the mixture of carbon dioxide or air containing carbon dioxide. At the same time the carbon dioxide reacts with the sodium hydroxide solution contained in the mixture.

The mixing ratio of the constituents forming the individual solutions is likewise dependent on the nature of the soils to be treated and can be determined by simple field trials or soil analysis. A temperature of 40 to 70° C. is preferably to be maintained in producing the first aqueous solution and a temperature of 90 to 120° C. is to be maintained in producing the second aqueous solution.

Saccharose acts as nutrient and is an energy carrier for the animals and microorganisms living in the soil. The saccharose should effectively activate the animals and microorganisms living in the soil to form humus. The proportion is measured according to circumstances.

A further development of the invention provides that the mixture also contains a third aqueous solution produced from phosphoric acid, potassium nitrate and tetrasodiumphosphate decahydrate under constant stirring as well as at least one salt, selected from the group containing water-soluble zinc, magnesium, copper, iron, selenium and manganese salts.

These materials are usually added in the ppm range and form important nutrients and trace elements both for the plants and for the animals and microorganisms living in the soil. The vitaliser increases the bioavailability of the materials.

The soil conditioner present as a concentrated aqueous solution can preferably be used in an aqueous dilution of approximately 1:100 to 1:10000.

It is also provided that the soil vitaliser can be used together with at least one industrial fertiliser, preferably dung, liquid manure or compost, and/or at least one commercial fertiliser.

This means that is possible to easily make dry soils low in nutrients, desert soils in particular, more viable. It has been proven that the soil vitaliser according to the present invention retains the nutrients of the fertiliser in the soil and causes improved availability of the nutrients for assimilation by the plants. Through use of industrial fertilisers desert soils, which are typically low in humus, receive a basic supply of humus-forming substances, for example with indigestible plant fibres.

In an advantageous embodiment of the invention the soil vitalisers can be used together with sewage sludge.

Sewage sludge is the sludge occurring with physical, chemical and biological waste water treatment, whereby the sewage sludge composition depends on the nature of the waste water and the waste water treatment process. Sewage usually contains sludge trace elements such as iron, zinc, copper and manganese as well as nutrients such as phosphate, nitrate and sulfate.

Due to its nutrient content sewage sludge is normally used as a valuable manure in agriculture, but does not give yields achieved with general use of other fertilisers. It has now eventuated that when the soil vitaliser according to the present invention is used together with the sewage sludge the yield is such that it corresponds to at least the agricultural yield gained from sole use of other fertilisers.

It is understood that legal conditions regarding harmful substances found in sewage sludge must be observed. But despite this there have been doubts expressed over using sewage sludge as manure, based on accumulation of harmful substances in the soil. These so-called harmful substances such as copper, manganese or zinc can be converted into vital, bioavailable trace elements by the soil vitaliser, resulting in increased plant growth.

In a similar further development the soil vitaliser can be used together with a liquid fertiliser, whereby the liquid fertiliser results from anaerobic fermentation of biomass, in particular agricultural waste, liquid manure, cow dung, biodegradable household waste or garden waste.

A fertiliser manufactured in this way contains all humus-forming materials which were already present prior to anaerobic fermentation in the biomass serving as starting material. Methane resulting from anaerobic fermentation can be utilised advantageously elsewhere as gaseous energy carrier. Through the combination of the liquid fertiliser containing the humus-forming materials with the soil conditioner according to the present invention when applied to the soil there is improved water storage, improved activation of the microbes living in the soil and thus loosening of the soil also. The effect of such loosening is that air from the soil surface can penetrate more deeply into the soil layers.

It has eventuated that the soil vitaliser also has a positive influence on the pH value of the liquid fertiliser.

Because of the humus-forming materials in the liquid fertiliser the mixture is particularly suitable for augmenting the fertility of the soil in desert soils. In the long term desert soil low in humus and storing little water only can be converted into a fertile soil. At the same time the soil is enriched with the nutrients required for plant growth and trace elements.

In another similar further development the soil vitaliser can be used together with ash, preferably wood ash. Wood ash contains important nutrients and trace elements such as potassium, phosphorous and calcium.

The present invention also relates to use of the inventive soil vitaliser as a water vitaliser.

Such a water vitaliser is particularly suited to restoration of the biological balance in waters and thus leads to a greater variety in those waters.

Increased growth in water plants, in particular algae and plankton, can be achieved especially by using the water vitaliser according to the present invention.

Algae are lower plants comprising single cells or cell systems. They are used inter alia as nutriments or, on account of their contents, serve as a valuable raw material source for obtaining alginates, alginic acid and carrageen, which have multiple applications. The prerequisite for economical utilisation of algae is, however, their cultivation which is partly not without problems in view of the loading of the water. There is where the water vitaliser comes in, producing an increase in algae yields.

Plankton is understood to mean all plant and animal organisms swimming freely in the sea or fresh water, which are mostly microscopically small and have no or minimal individual motion only. Plant plankton serves as nourishment for animal plankton, which is in turn a source of nourishment for fish and other water dwellers. Fish in turn constitute a source of nourishment for humans. The water vitaliser in this case provides a strong increase of plankton and thus an increase in fish stocks.

An advantageous embodiment of the invention provides that the water used to manufacture the solutions and dilutions of the soil and water vitalisers is magnetised water.

Magnetised and accordingly vitalised water holds an extraordinary significance for the life of plants and animals.

It is known in the case of natural water that due to the dipole character of the water molecules a so-called cluster formation between the water molecules results, which has a positive effect on the vitality of humans, animals and plants. Due to impurities contained in the water the natural cluster formation of the water changes such that the positive effect is disturbed. Magnetised water does not have these negative changes in the cluster formation. This knowledge, currently under scientific investigation but yet to be fully explained, is utilised in the present invention. Due to the production of the solutions according to the present invention, the mixtures and the dilutions with vitalised water a lasting positive effect is made on the nature of the soil treated with the agent and water.

1. A soil conditioner comprising a soil-tolerant electrolyte and sugar, characterised in that the soil conditioner is a mixture of a first aqueous solution comprising sodium hydroxide, acetic acid and 1,2,3-propanetriol produced under constant stirring and a second aqueous solution comprising saccharose, acetic acid and potassium hydrogentartrate produced under constant stirring.

2. The soil conditioner as claimed in claim 1, characterised in that the mixing ratio between the first aqueous solution and the second aqueous solution is approximately 1:10 to 1:50, whereby a temperature of 80° C. is not exceeded when the solutions are being mixed.

3. The soil conditioner as claimed in claim 1 or 2, characterised in that when the solutions are being mixed air, pure carbon dioxide and/or pure oxygen are introduced to the mixture.

4. The soil conditioner as claimed in any one of claims 1 to 3, characterised in that as the first aqueous solution is being produced a temperature of 40 to 70° C. is to be maintained and as the second aqueous solution is being produced a temperature of 90 to 120° C. is to be maintained.

5. The soil conditioner as claimed in any one of claims 1 to 4, characterised in that the mixture additionally contains an aqueous solution of phosphoric acid, potassium nitrate and tetrasodium diphosphate decahydrate under constant stirring as well as at least one salt, selected from the group comprising water-soluble zinc, magnesium, copper, iron and manganese salts.

6. The soil conditioner as claimed in any one of claims 1 to 5, characterised in that the aqueous soil conditioner is a concentrated solution which can be employed in an aqueous dilution of 1:100 to 1:10000.

7. The soil conditioner as claimed in any one of claims 1 to 6, characterised in that the soil conditioner can be used together with at least one industrial fertiliser, preferably dung, liquid manure or compost, and/or at least one commercial fertiliser.

8. The soil conditioner as claimed in any one of claims 1 to 7, characterised in that the soil conditioner can be used together with sewage sludge.

9. The soil conditioner as claimed in any one of claims 1 to 8, characterised in that the soil conditioner can be used together with a liquid fertiliser, whereby the liquid fertiliser results from the anaerobic fermentation of biomass, in particular agricultural waste, liquid manure, cow dung, biodegradable household waste or garden waste.

10. The soil conditioner as claimed in any one of claims 1 to 9, characterised in that the soil conditioner can be used together with ash, preferably wood ash.

11. The soil conditioner as claimed in any one of claims 1 to 10 as water vitaliser.

12. The soil conditioner as claimed in any one of claims 1 to 10 or the water vitaliser as claimed in claim 11, characterised in that the water used for producing the solutions and dilutions is magnetic water.
